(19) United States
(12) Patent Application Publication
(10) Pub. No.: US 2026/0208602 A1
(43) Pub. Date: Jul. 23, 2026

(54) SECONDARY POWER SOURCE FOR AN ELECTRIC VEHICLE

(71) Applicant: Frederick Haines, Wichita, KS (US)

(72) Inventor: Frederick Haines, Wichita, KS (US)

(21) Appl. No.: 19/034,262

(22) Filed: Jan. 22, 2025

(51) Int. Cl. B60L 50/62; B60L 58/13

(52) U.S. Cl. CPC B60L 50/62; B60L 58/13

(57) ABSTRACT

A secondary power source for an electric vehicle includes a generator, a starter motor, and a switch box. The generator is connectable by a first wiring to a battery of an electric vehicle to charge the battery. The starter motor is connected to the generator. The starter motor is designed to start the generator. The switch box is connected to the starter motor by a second wiring. The switch box is connectable to the battery by a third wiring. The switch box is connectable to a computer of the electric vehicle by a fourth wiring. The switch box is designed to be actuated when the computer senses a charge level of the battery below a predetermined value to selectively transmit power from the battery to the starter motor to activate the starter motor and the generator and charge the battery.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to power sources for electric vehicles and more particularly pertains to a new secondary power source for an electric vehicle. Electric vehicles are normally charged at charging stations, which can be problematic if none are nearby. Even if charging stations are available, the charge time can be from 45 minutes to an hour at not an insubstantial cost. The secondary power source includes a generator mountable in a vehicle and connectable to the battery of the electric vehicle to charge the battery, thereby providing the driver with an alternative to using a charging station.

### (2) Description of Related Art including information disclosed under 37 CFR 1.97 and 1.98

The prior art relates to different auxiliary power sources for electric vehicles. The prior art, as best understood, does not disclose a secondary power source for an electric vehicle includes a generator, a starter motor, and a switch box. The switch box is designed to be actuated when the computer senses a charge level of the battery below a predetermined value to selectively transmit power from the battery to the starter motor to activate the starter motor and the generator and charge the battery.

### (h) BRIEF SUMMARY OF THE INVENTION

An embodiment of the disclosure meets the needs presented above in a secondary power source for an electric vehicle generally comprising a generator, a starter motor, and a switch box. The generator is connectable by a first wiring to a battery of an electric vehicle to charge the battery. The starter motor is connected to the generator. The starter motor is designed to start the generator. The switch box is connected to the starter motor by a second wiring. The switch box is connectable to the battery by a third wiring. The switch box is connectable to a computer of the electric vehicle by a fourth wiring. The switch box is designed to be actuated when the computer senses a charge level of the battery below a predetermined value to selectively transmit power from the battery to the starter motor to activate the starter motor and the generator and charge the battery.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(s)

The disclosure will be better understood and objects other than those set forth above will become apparent when consideration is given to the following detailed description thereof. Such description makes reference to the annexed drawings wherein:

FIG. 1 is a side view of a secondary power source according to an embodiment of the disclosure.

FIG. 2 is a block diagram view of an embodiment of the disclosure.

FIG. 3 is a top view of an embodiment of the disclosure in use.

FIG. 4 is a side view of an embodiment of the disclosure in use.

FIG. 5 is a perspective view of an embodiment of the disclosure in use.

FIG. 6 is a side view of an alternative embodiment of the secondary power source.

### (j) DETAILED DESCRIPTION OF THE INVENTION

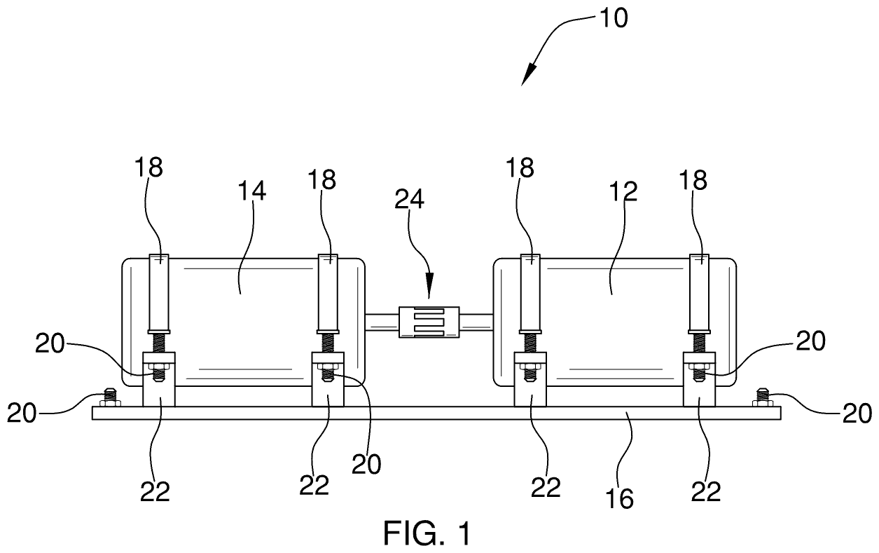

With reference now to the drawings, and in particular to FIGS. 1 through 5 thereof, a new secondary power source embodying the principles and concepts of an embodiment of the disclosure and generally designated by the reference numeral 10 will be described.

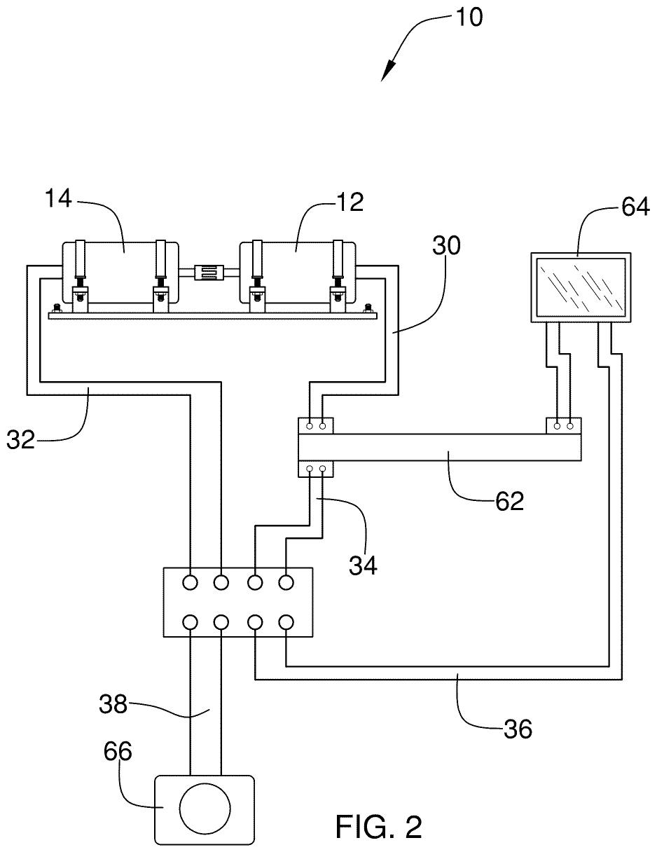

As best illustrated in FIGS. 1 through 5, the secondary power source 10 generally comprises a generator 12, a starter motor 14, and a switch box 16. As shown in the exemplary embodiment in the diagram in FIG. 2, the generator 12 is connectable by a first wiring 30 to a battery 62 of an electric vehicle 60 to charge the battery 62. The starter motor 14 is connected to the generator 12. The starter motor 14 is designed to start the generator 12. The switch box 16 is connected to the starter motor 14 by a second wiring 32. The switch box 16 is connectable to the battery 62 by a third wiring 34. The switch box 16 is connectable to a computer 64 of the electric vehicle 60 by a fourth wiring 36. The switch box 16 is designed to be actuated when the computer 64 senses a charge level of the battery 62 below a predetermined value to selectively transmit power from the battery 62 to the starter motor 14 to activate the starter motor 14 and the generator 12 and charge the battery 62. It should be noted that the view in FIG. 2 is a schematic view and more than one switch box 16 or switches could be used in any suitable configuration to control the flow of power and activation of the various components.

The switch box 16 is connectable to a charging port 66 of the electric vehicle 60 by a fifth wiring 38 such that power from a charging station is conducted to the battery 62. Therefore, when a user wishes to charge the battery 62 in the standard manner via the charging port 66, the user can plug the connector of the charging station into the charging port 66 and charge the battery 62.

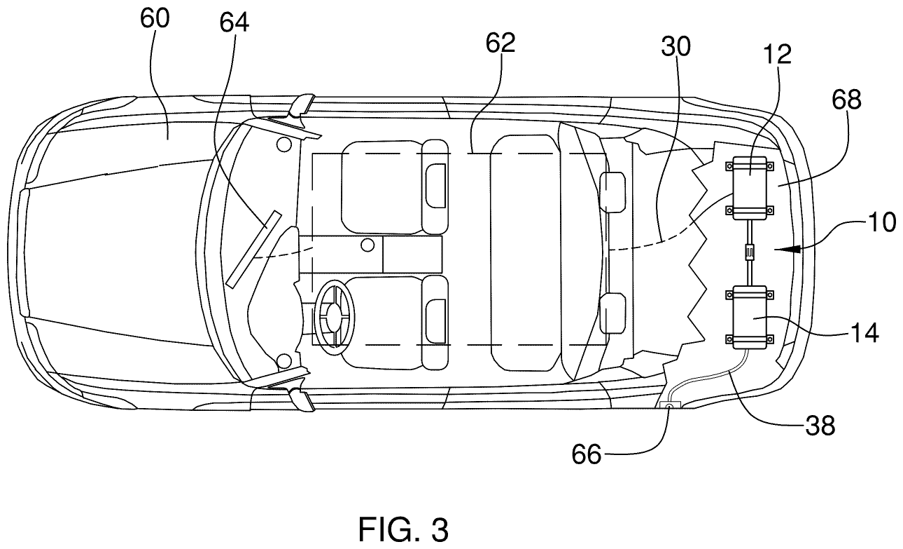

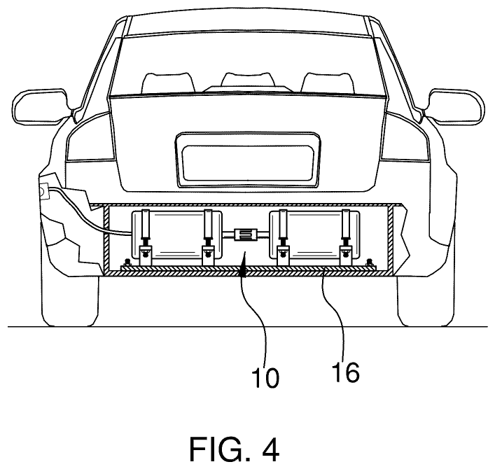

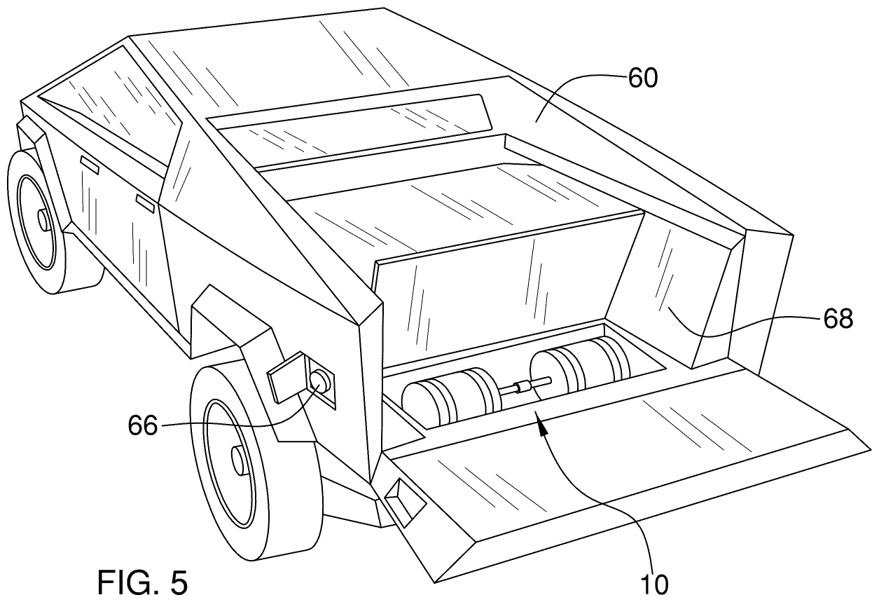

The secondary power source 10 further includes a support plate 16 that is designed to be mounted in a trunk 68 area of the electric vehicle 60, wherein each of the starter motor 14 and the generator 12 is coupled to the support plate 16. In the exemplary embodiment in FIG. 1, the secondary power source 10 further includes a first pair of brackets 18 wrapped over the generator 12 to secure the generator 12 to the support plate 16. The secondary power source 10 also includes a second pair of brackets 18 wrapped over the starter motor 14 to secure the generator 12 to the support plate 16. As shown in FIG. 1, the brackets 18 could be metal bands or straps with bolts 20 to engage mounts 22 attached to the support plate 16, which mounts 22 also support the starter motor 14 and the generator 12. FIGS. 3 and 4 show an installation in a trunk 68 of a sedan-style electric vehicle 60, and FIG. 5 shows installation in a compartment in the trunk 68 area of a Tesla Cybertruck®. In FIG. 3, the fifth wiring 38 connects the charging port and the starter motor 14. The first wiring 30 connects the battery 62 and the generator 12. As best seen in FIG. 4, the support plate 16 is attached to the floor or the underside of the frame by the bolts 20.

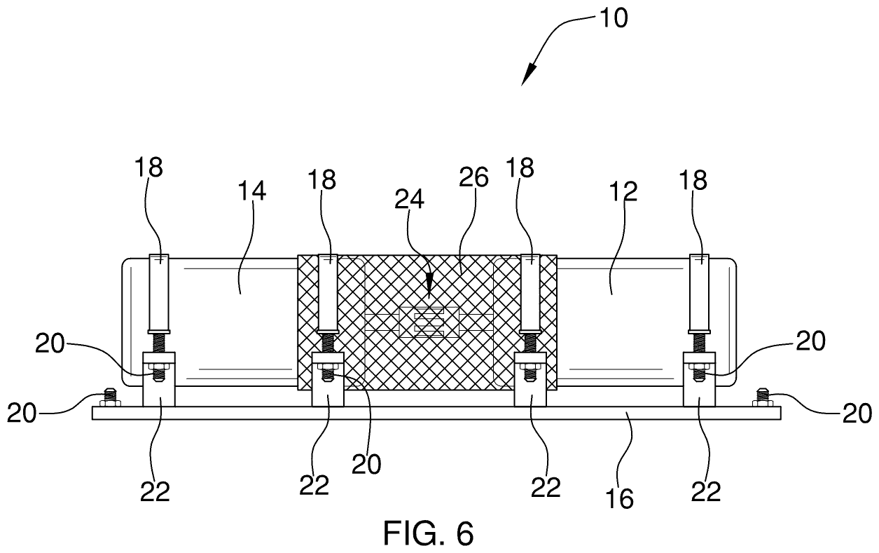

The secondary power source 10 further includes a split clamp coupling 24 connecting the starter motor 14 to the generator 12, as shown in FIG. 1. However, a single spindle or drive rod could be used in another possible embodiment. The generator 12 could be of any design suitable for placement in the electric vehicle 60, such as a diesel generator 12. As shown in FIG. 6, the split clamp coupling 24 could be enclosed by a cover 26, which in the exemplary embodiment is in the form of a wire metal cage, though a solid cover is within the scope of the disclosure. The cover 26 has a generally cylindrical, sleeve-like shape and is held in place by two of the brackets 18 around the ends of the generator 12 and the starter motor 14. Other designs of the cover 26, such as extending completely over both the generator 12 and the starter motor 14 and/or being mounted on the support plate 16 are within the scope of the disclosure.

The secondary power source 10 can be used to charge the battery 62 of the electric vehicle 60 after the user has operated the electric vehicle 60 and depleted the battery 62. When the battery 62 is at a charge level below a predetermined level, the switch box 16 is actuated. The generator 12 is activated by the starter motor 14 and charges the battery 62. In one possible embodiment, the predetermined level is in the range of 20% to 30% of a full charge. For example, when the battery 62 is below 30% of full charge, the starter motor 14 is activated by the computer 64 using the power of the battery 62, which is sufficient to activate the starter motor 14. In one possible embodiment, the generator 12 is stopped when the battery 62 is charged to a predetermined level less than a full charge, such as a charge level in the range of 80% to 98%.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A secondary power source for an electric vehicle comprising:
a generator being connectable by a first wiring to a battery of an electric vehicle to charge the battery;
a starter motor being connected to said generator, said starter motor being configured to start said generator; and
a switch box being connected to said starter motor by a second wiring, said switch box being connectable to the battery by a third wiring, said switch box being connectable to a computer of the electric vehicle by a fourth wiring, said switch box being configured to be actuated when the computer senses a charge level of the battery below a predetermined value to selectively transmit power from the battery to said starter motor to activate said starter motor and said generator and charge the battery.

2. The secondary power source of claim 1, wherein said switch box is connectable to a charging port of the electric vehicle by a fifth wiring such that power from a charging station is conducted to the battery.

3. The secondary power source of claim 1, further including a support plate being configured to be mounted in a trunk area of the electric vehicle, wherein each of said starter motor and said generator is coupled to said support plate.

4. The secondary power source of claim 1, further including a first pair of brackets wrapped over said generator to secure said generator to said support plate.

5. The secondary power source of claim 4, further including a second pair of brackets wrapped over said starter motor to secure said generator to said support plate.

6. The secondary power source of claim 1, further including a split clamp coupling connecting said starter motor to said generator.

7. The secondary power source of claim 2, further including a support plate being configured to be mounted in a trunk area of the electric vehicle, wherein each of said starter motor and said generator is coupled to said support plate.

8. The secondary power source of claim 7, further including a first pair of brackets wrapped over said generator to secure said generator to said support plate.

9. The secondary power source of claim 8, further including a second pair of brackets wrapped over said starter motor to secure said generator to said support plate.

10. The secondary power source of claim 9, further including a split clamp coupling connecting said starter motor to said generator.

11. A method of charging a battery of an electric vehicle, said method comprising the steps of:
providing a secondary power source for the electric vehicle comprising:
a generator being connectable by a first wiring to a battery of an electric vehicle to charge the battery;
a starter motor being connected to said generator, said starter motor being configured to start said generator; and
a switch box being connected to said starter motor by a second wiring, said switch box being connectable to the battery by a third wiring, said switch box being connectable to a computer of the electric vehicle by a fourth wiring, said switch box being configured to be actuated when the computer senses a charge level of the battery below a predetermined value to selectively transmit power from the battery to said starter motor to activate said starter motor and said generator and charge the battery;
operating the electric vehicle and depleting the battery;
actuating said switch box when the battery is at a charge level below a predetermined level; and
activating said generator with said starter motor and charging the battery.

12. The method of claim 11, further comprising the step of stopping said generator when the battery is charged to a predetermined level less than a full charge.
